(19) United States
(12) Patent Application Publication
(10) Pub. No.: US 2006/0060038 A1
(43) Pub. Date: Mar. 23, 2006

(54) Method for processing products having low tolerances by removing shavings

(76) Inventor: Roberto Sammartin, Selvazzano Dentro (IT)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 10/546,344

(22) PCT Filed: Feb. 20, 2004
(86) PCT No.: PCT/IT04/00075

§ 371 Date: Aug. 18, 2005

(30) Foreign Application Priority Data
Feb. 28, 2003 (IT) FI02003 A 000039

(51) Int. Cl. B23B 3/00

(52) U.S. Cl. 82/1.11; 82/900; 409/188

(57) ABSTRACT

A method for processing products having low tolerances by removing shavings, including a processing step for finishing the workpiece being processed (2), comprises a step for detecting temperature (T) of the workpiece being processed (2) before or at the same time as the finishing step and a step for adjusting the finishing depths in accordance with the detected temperature value.

### TECHNICAL FIELD

The present invention relates to a method for processing products having low dimensional tolerances by removing shavings.

### TECHNOLOGICAL BACKGROUND

It is known that metal materials are particularly prone to expansion phenomena when heated. It is also known that mechanical production operations for removing shavings, Including in particular turning operations, produce substantial heating of the processed workpiece. This leads to the workpiece which is being processed being subjected to greater or lesser expansions.

This must be taken into consideration when products having low dimensional tolerances have to be processed.

In order to comply with high levels of precision during work cycles, it is known to entrust the evaluation of the dimensional variations resulting from the temperature of the workpiece to the experience of the operator, who is therefore responsible for deciding by estimation any adjustment to the finishing depths of the workpiece.

However, this is a source of possible production rejects before the setting of the machine tool is at an optimum level and needs new adjustments each time the temperature of the workpiece being processed Is subjected to changes, for example, owing to wear of the tool or for other reasons.

As an alternative, it is known from American U.S. Pat. No. 6,449,526 to provide a machine tool, in particular a grinding centre, with dimensional control means for the workpieces being processed. This dimensional control is preferably carried out by means of an optical control effected by means of appropriate telecameras. In this manner, it is possible to detect the effective dimensions of the part being processed in order to take them into consideration when the machine is programmed or reprogrammed. This system, in addition to being particularly costly, requires at least temporary stopping of the machine in order to carry out the measurements. It is further preferable for the means for taking the measurement, owing to the sophistication thereof, normally to be located outside the machine and to be introduced only at the time of the measurement. This leads to a further increase in the production times owing to the need to position, test and then remove the measurement means.

### STATEMENT OF INVENTION

The technical problem addressed by the present invention is to provide a method for processing products having low tolerances by removing shavings, which method is set out so as to allow the disadvantages mentioned with reference to the cited prior art to be overcome.

This problem is solved by the invention by a method carried out in accordance with the appended claims.

### BRIEF DESCRIPTION OF THE DRAWINGS

The characteristics and advantages of the invention will be better appreciated from the detailed description of one preferred embodiment which is illustrated purely by way of non-limiting example with reference to the appended drawings, in which:

FIG. 1 is a schematic flow chart showing the method of the invention;

FIG. 2 is a schematic view of a workpiece being turned by the method of the invention.

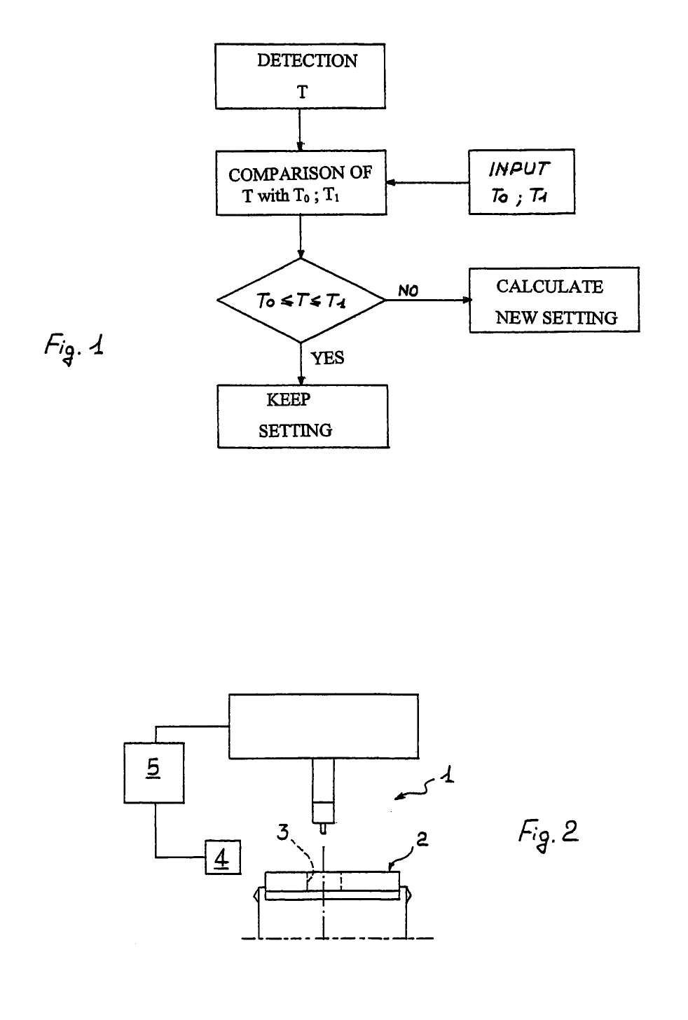

### PREFERRED EMBODIMENT OF THE INVENTION

With reference to the appended Figures, a machine tool, such as a CNC turning centre 1 which is arranged for processing a workpiece 2, for example, in order to carry out the finishing processing of the surface 3 thereof, is provided according to the invention with a thermometric device 4, preferably of the non-contact type, such as an optical sensor or laser type sensor of the type known per se. The thermometric sensor device 4 is directed towards the surface 3 (processed diameter) so as to allow temperature T thereof to be detected in the step immediately before the finishing processing. The device 4 is also connected to a unit 5 for processing temperature signal T detected, in which, in addition to processing the signal in order to obtain the temperature value detected, a comparison is carried out between detected temperature T and the expected nominal temperature for the correct processing tolerances to be obtained. In particular, it is checked as to whether or not detected temperature T falls within a range about the nominal temperature, delimited by lower limit temperature T₀ and upper limit temperature T₁, respectively.

Temperatures T₀ and T₁ are defined in accordance with the characteristics of the material being processed, as well as the degree of precision required by the processing operation.

When detected temperature T falls within the above-defined range, the processing is considered to be within normal values so that the thermal expansions of the workpiece being processed do not compromise to a significant degree the permissible dimensional tolerances. In this case, no correction is carried out to the processing parameters of the machine with specific reference to the finishing processing of the surface 3.

If the result of the temperature comparison falls outside this temperature range, however, the processing unit produces a correction signal which acts on the numerical control of the turning centre 1 in order to change the depths of finishing of the surface 3 so as to compensate for the detrimental thermal effect.

In this manner, a substantial level of reproducibility and consistency are obtained in the processing tolerances, even for very precise processing operations, reducing, if not eradicating, rejects owing to dimensional errors.

1. A method for processing products having low tolerances by removing shavings, including a processing step for finishing the workpiece being processed (2), characterized in that it comprises a step for detecting temperature (T) of the workpiece being processed (2) before or at the same time as the finishing step and a step for adjusting the finishing depths in accordance with the detected temperature value.

2. A processing method according to claim 1, wherein the step for detecting the temperature of the workpiece is carried out in the step immediately before the finishing step.

3. A processing method according to claim 1, wherein the temperature of the workpiece is detected by non-contact measuring means (4).

4. A processing method according to claim 2, wherein the temperature of the workpiece is detected by optical measuring means.

5. A processing method according to claim 1, wherein the processing by removing shavings is a turning process and temperature (T) of the workpiece (2) is detected in the region of a processed diameter (3).

6. A processing method according to claim 1, wherein the step for adjusting the finishing depths is carried out by comparing the detected value of temperature (T) with a reference temperature (T₀; T₁) and changing the finishing depths in accordance with the thermal expansion of the material which constitutes the workpiece being processed, taking into consideration the difference between detected temperature (T) and reference temperature (T₀; T₁).

7. A processing method according to claim 2, wherein the temperature of the workpiece is detected by non-contact measuring means (4).
